(19) United States
(12) Patent Application Publication
(10) Pub. No.: US 2015/0321029 A1
(43) Pub. Date: Nov. 12, 2015

(54) Window Breaking Assembly

(71) Applicant: Ricky R. Mitchem, Somerset, KY (US)

(72) Inventor: Ricky R. Mitchem, Somerset, KY (US)

(21) Appl. No.: 14/272,974

(22) Filed: May 8, 2014

(51) Int. Cl. A62B 3/00; B25D 5/00

(52) U.S. Cl. CPC A62B 3/005; B25D 5/00

(57) ABSTRACT

A window breaking assembly for breaking a vehicle window in an emergency such that a passenger in the vehicle is protected from broken glass includes a rod that has a first end and a second end. A pressure plate is coupled to the first end of the rod. A punch is operationally coupled to the pressure plate. The punch selectively generates a thrusting inertia. The punch is positionable against a vehicle window. The pressure plate is engaged by a user so the punch generates the thrusting inertia. The punch shatters the vehicle window.

### BACKGROUND OF THE DISCLOSURE

### Field of the Disclosure

The disclosure relates to punch devices and more particularly pertains to a new punch device for breaking a vehicle window in an emergency such that a passenger in the vehicle is protected from broken glass.

### SUMMARY OF THE DISCLOSURE

An embodiment of the disclosure meets the needs presented above by generally comprising a rod that has a first end and a second end. A pressure plate is coupled to the first end of the rod. A punch is operationally coupled to the pressure plate. The punch selectively generates a thrusting inertia. The punch is positionable against a vehicle window. The pressure plate is engaged by a user so the punch generates the thrusting inertia. The punch shatters the vehicle window.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom perspective view of a window breaking assembly according to an embodiment of the disclosure.

FIG. 2 is a top perspective view of an embodiment of the disclosure.

FIG. 3 is a perspective view of an embodiment of the disclosure in a stored position.

FIG. 4 is a right side view of an embodiment of the disclosure.

### DESCRIPTION OF THE PREFERRED EMBODIMENT

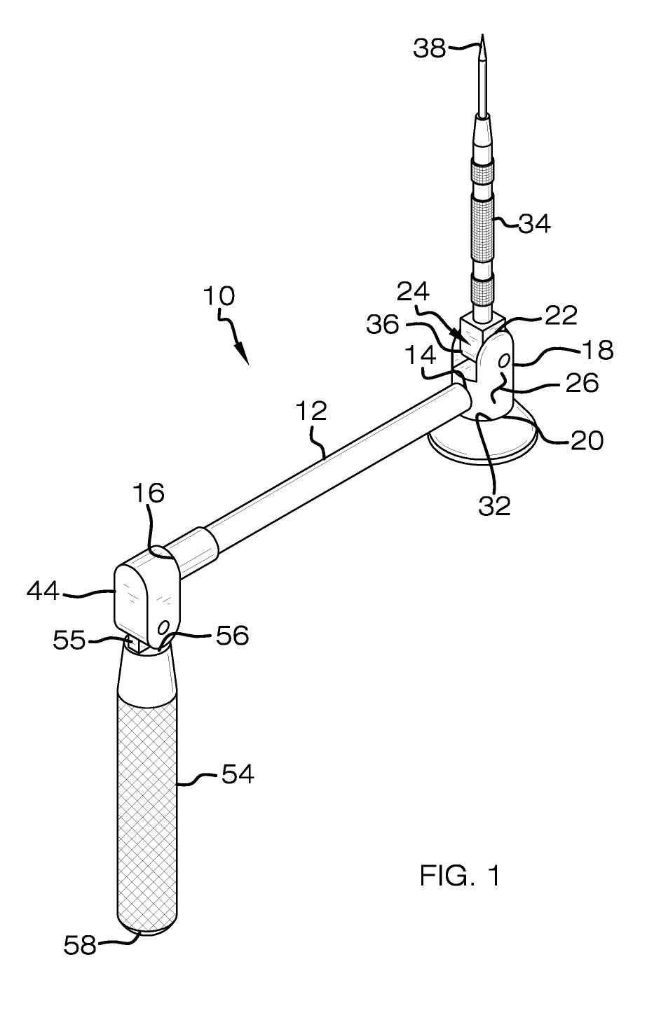

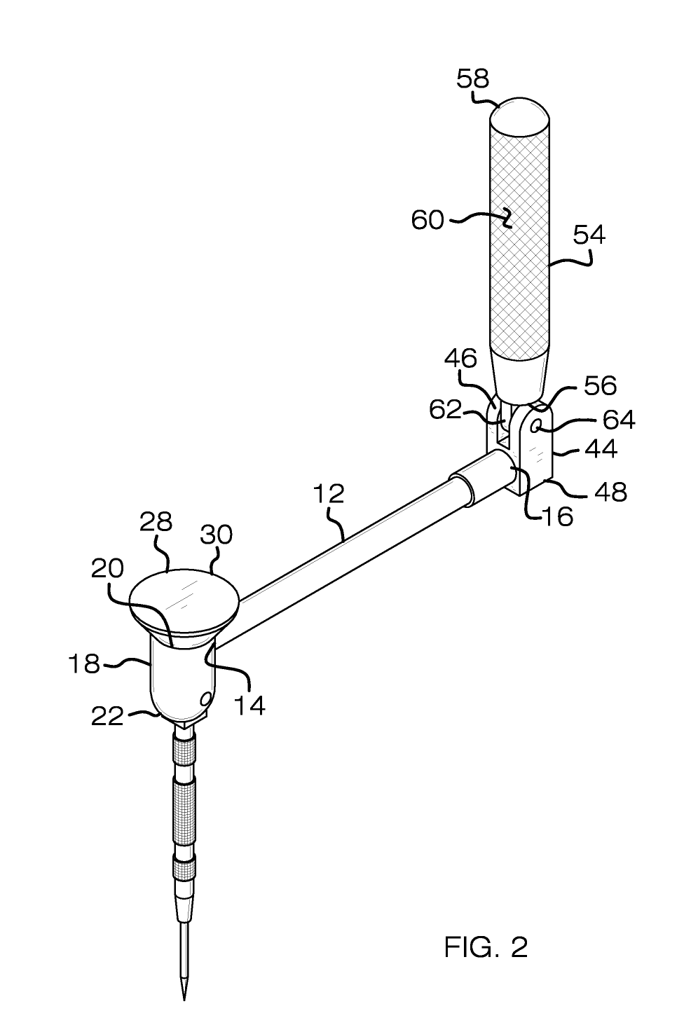

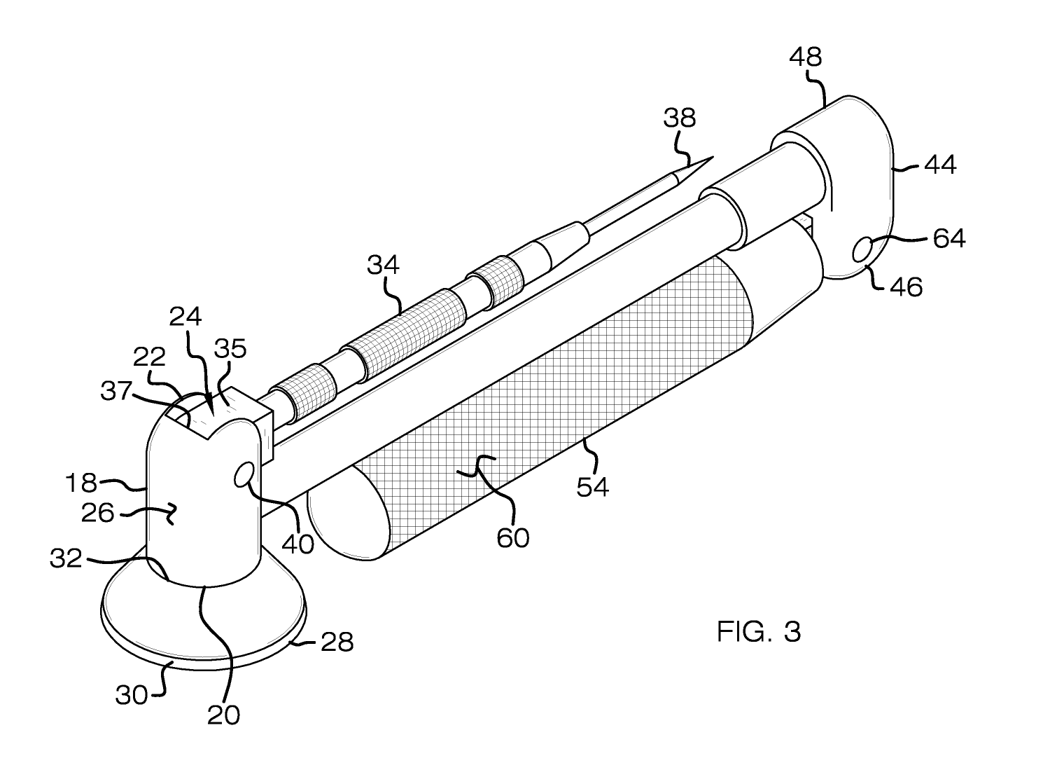

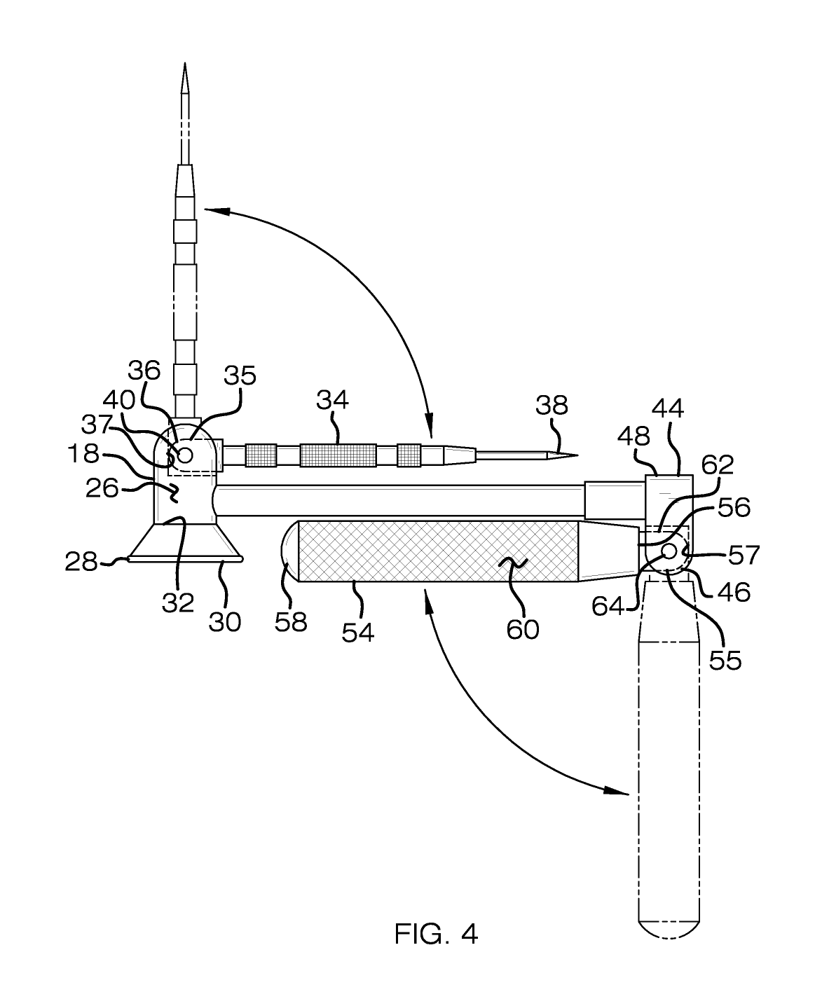

With reference now to the drawings, and in particular to FIGS. 1 through 4 thereof, a new punch device embodying the principles and concepts of an embodiment of the disclosure and generally designated by the reference numeral 10 will be described.

As best illustrated in FIGS. 1 through 4, the window breaking assembly 10 generally comprises a rod 12 that has a first end 14 and a second end 16. The rod 12 is elongated between the first 14 and second 16 ends. A first mount 18 has a top end 20 and a bottom end 22. The top end 20 of the first mount 18 has a channel 24 extending downwardly therein.

An exterior surface 26 of the first mount 18 is coupled to the first end 14 of the rod 20. The rod 12 is positioned proximate the bottom end 22 of the first mount 18. The first mount 18 is oriented such that a line extending through the top 20 and bottom 22 ends of the first mount 18 is perpendicular to a line extending through the first 14 and second 16 ends of the rod 20. The exterior surface 26 of the first mount 18 may be curved so the first mount 18 has a cylindrical shape.

A pressure plate 28 is provided. An exterior edge 30 of the pressure plate 28 is curvilinear. The pressure plate 28 has a disk shape. A bottom surface 32 of the pressure plate 28 is coupled to the top end 20 of the first mount 18.

A punch 34 has a static end 36 and a dynamic end 38. The static end 36 of the punch 34 is hingedly coupled to the bottom end 22 of the first mount 18. Moreover, the static end 36 of the punch 34 is positioned within the channel 24. A pin 40 extends through the first mount 18 and engages the static end 36 of the punch 34. The pin 40 retains the punch 34 on the first mount 18.

The dynamic end 42 of the punch 34 tapers into a point. The dynamic end 42 of the punch 34 selectively generates a thrusting inertia. The punch 34 may be a spring loaded punch of any conventional design.

The punch 34 is positionable in a deployed position. The punch 34 is oriented perpendicular to the rod 12 when the punch 34 is positioned in the deployed position. A first lateral side 35 of the static end 36 of the punch 34 abuts a rear surface 37 of the channel 24 when the punch 34 is in the deployed position. The punch 34 is positionable in a stored position. The punch 34 extends laterally along the rod 12 when the punch 34 is positioned in the stored position.

A second mount 44 has an upper end 46 and a lower end 48. The upper end 46 of the second mount 44 has a groove 50 extending downwardly therein. An outer surface 52 of the second mount 44 is coupled to the second end 16 of the rod 12. The second end 16 of the rod 12 is positioned proximate the upper end 46 of the second mount 44. The second mount 44 is oriented such that a line extending through the upper 46 and lower 48 ends of the second mount 44 is perpendicular to the line extending through the first 14 and second 16 ends of the rod 12.

A handle 54 has a coupled end 56 and a free end 58. The handle 54 is elongated. An outermost surface 60 of the handle 54 tapers inwardly toward the coupled end 56 of the handle 54. Additionally, the outermost surface 60 of the handle 54 may be knurled.

A tab 62 is coupled to and extends away from the coupled end 56 of the handle 54. The tab 62 on the handle 54 is hingedly coupled to the second mount 44. Moreover, the tab 62 is positioned within the groove 50. A pin 64 extends through the second mount 44 and engages the tab 62. The pin 64 retains the handle 54 on the second mount 44.

The handle 54 is positionable in a deployed position. The handle 54 extends upwardly from the rod 12 in the deployed position. A first oblique side 55 of the tab 62 abuts a rearward surface 57 of the groove 50 when the handle 54 is in the deployed position. Additionally, the handle 54 is positionable in a stored position. The handle 54 extends laterally along the rod 12 in the stored position.

In use, the punch 34 and the handle 54 are each positioned in the deployed position. The dynamic end 42 of the punch 34 is positioned against a vehicle window. A top surface 66 of the pressure plate 28 is engaged by a user until the punch 34 generates the thrusting inertia. The dynamic end 38 of the punch 34 transfers the thrusting inertia into the vehicle window.

The vehicle window is shattered. Additionally, the shattered vehicle window falls downwardly so the shattered vehicle window does not impact an occupant of the vehicle. The assembly 10 is utilized in an emergency situation by police officers, firemen or other emergency responders who need to gain access to an interior of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A window breaking assembly for breaking a vehicle window in an emergency such that a passenger in the vehicle is protected from broken glass, said assembly comprising:
a rod having a first end and a second end;
a pressure plate coupled to said first end of said rod;
a punch operationally coupled to said pressure plate, said punch selectively generating a thrusting inertia; and
said punch being positionable against the vehicle window, said pressure plate being engaged by a user such that said punch generates said thrusting inertia wherein the vehicle window is shattered.

2. The assembly according to claim 1, wherein said rod being elongated between said first and second ends.

3. The assembly according to claim 1, wherein a first mount having a top end and a bottom end, said bottom end of said first mount having a channel extending downwardly therein.

4. The assembly according to claim 1, wherein an exterior surface of a first mount being coupled to said first end of said rod such that said rod is positioned proximate a top end of said first mount.

5. The assembly according to claim 4, wherein said first mount being oriented such that a line extending through a top end and a bottom end of said first mount is perpendicular to a line extending through said first and second ends of said rod.

6. The assembly according to claim 1, wherein an exterior edge of said pressure plate being curvilinear such that said pressure plate has a disk shape.

7. The assembly according to claim 1, wherein a bottom surface of said pressure plate being coupled to a top end of a first mount.

8. The assembly according to claim 1, wherein said punch having a static end and a dynamic end, said static end of said punch being hingedly coupled to a bottom end of a first mount such that said static end of said punch is positioned within a channel.

9. The assembly according to claim 1, wherein said a second mount having an upper end and a lower end, said upper end of said second mount having a groove extending downwardly therein.

10. The assembly according to claim 1, wherein an outer surface of a second mount being coupled to said second end of said rod such that said second end of said rod is positioned proximate an upper end of said second mount.

11. The assembly according to claim 10, wherein said second mount being oriented such that a line extending through an upper end and a lower end of said second mount is perpendicular to a line extending through said first and second ends of said rod.

12. The assembly according to claim 1, wherein a handle having a coupled end and a free end, said handle being elongated.

13. The assembly according to claim 1, wherein a tab coupled to and extending away from a coupled end of a handle.

14. The assembly according to claim 1, wherein a tab on a handle being hingedly coupled to a second mount such that said tab is positioned within a groove.

15. A window breaking assembly for breaking a vehicle window in an emergency such that a passenger in the vehicle is protected from broken glass, said assembly comprising:
a rod having a first end and a second end, said rod being elongated between said first and second ends;
a first mount having a top end and a bottom end, said top end of said first mount having a channel extending downwardly therein, an exterior surface of said first mount being coupled to said first end of said rod such that said rod is positioned proximate said bottom end of said first mount, said first mount being oriented such that a line extending through said top and bottom ends of said first mount is perpendicular to a line extending through said first and second ends of said rod;
a pressure plate, an exterior edge of said pressure plate being curvilinear such that said pressure plate has a disk shape, a bottom surface of said pressure plate being coupled to said top end of said first mount;
a punch having a static end and a dynamic end, said static end of said punch being hingedly coupled to said bottom end of said first mount such that said static end of said punch is positioned within said channel, said dynamic end of said punch selectively generating a thrusting inertia;
a second mount having an upper end and a lower end, said upper end of said second mount having a groove extending downwardly therein, an outer surface of said second mount being coupled to said second end of said rod such that said second end of said rod is positioned proximate said upper end of said second mount, said second mount being oriented such that a line extending through said upper and lower ends of said second mount is perpendicular to said line extending through said first and second ends of said rod;
a handle having a coupled end and a free end, said handle being elongated;
a tab coupled to and extending away from said coupled end of a handle, said tab on said handle being hingedly coupled to said second mount such that said tab is positioned within said groove; and
said dynamic end of said punch being positionable against the vehicle window, a top surface of said pressure plate being engaged by a user such that said punch generates said thrusting inertia wherein the vehicle window is shattered.
